(19) United States
(12) Patent Application Publication
(10) Pub. No.: US 2006/0093320 A1
(43) Pub. Date: May 4, 2006

(54) Operation modes for a personal video recorder using dynamically generated time stamps

(76) Inventors: Bryan S. Hallberg, Vancouver, WA (US); Kim Wells, Washougal, WA (US); Vishnu Kumar, Vancouver, WA (US)

Correspondence Address: MARGER JOHNSON & MCCOLLOM, P.C., 210 SW MORRISON STREET, SUITE 400, PORTLAND, OR, 97204, US

(21) Appl. No.: 11/252,423

(22) Filed: Oct. 17, 2005

Related U.S. Application Data
(60) Provisional application No. 60/623,395, filed on Oct. 29, 2004.

(51) Int. Cl. H04N 5/783

(52) U.S. Cl. 386/68; 386/69; 386/70

(57) ABSTRACT

A Personal Video Recorder (PVR) generates an object index table in real-time that can be updated while streaming media is being encoded and stored in memory. This allows more dynamic video trick mode operations such as fast forward, reverse and skip. The PVR also provides automatic data rate control that prevents video frames from being dropped thus preventing jitter in the output media.

### BACKGROUND OF THE INVENTION

1. Technical Field

This disclosure is directed to personal video recorders, and, more specifically, to a personal video recorder having multiple methods for data playback.

2. Description of the Related Art

Personal video recorders (PVRs) can display both real-time and time shifted video. Prior art PVRs have a “real-time” video display mode, but, typically, such a mode is not truly in real time. Instead, it has a few second delay from true real time. In these prior art PVRs, the video stream is first compressed and stored onto a storage media, then read from the media and decompressed before it is shown on the display. Typically the media is memory or a hard disk drive (HDD), but could be another type of storage. The compression and decompression of the video signal can cause visual artifacts in the video, such that the displayed video has a lower fidelity than the original video.

The minimum amount of delay possible between receiving an original image and presenting the decoded image in such prior art systems is the minimum time required to encode, store to disk (or file), read from disk, and decode. Typically this is on the order of a few seconds. The exact amount of time is dependent upon the HDD latency. To compensate for HDD latency, an encoding “smoothing buffer” is sometimes placed between encoder and the HDD on the encode signal path, and similarly, a decoding smoothing buffer is placed between the HDD and the decoder on the decode signal path. These buffers allow the encoder and decoder to run at a constant rate, while the HDD can store and retrieve data in bursts.

If users of these prior art PVRs try to jump back in time a short distance from the real-time video, such that the encoded video was in the encode buffer and not yet written to the disk, the operation would be prohibited. Also, if the video was currently playing in fast forward mode, a discontinuity would occur when the video moves from decoding from the disk to displaying the real-time video.

Due to these transport issues, prior art PVRs display video that has been compressed, stored on a disk, and decompressed, produce video quality that is not as good as the original video signal. As discussed above, it can take up to several seconds for video to be processed by the PVRs. The latency video during input changes also suffers from display latency. Thus, channel changes and menu selections can take much longer than they would otherwise appear. As a result, the user does not immediately see a video change, after, for instance, a button on a remote is pressed. Rather the user only sees the change after the input video has been compressed, stored, read, and decompressed. Such latency is frustrating for viewers.

Embodiments of the invention address these and other problems in the prior art.

### SUMMARY OF THE INVENTION

A Personal Video Recorder (PVR) generates an object index table in real-time that can be updated while streaming media is being encoded and stored in memory. This allows more dynamic video trick mode operations such as fast forward, reverse and skip. The PVR also provides automatic data rate control that prevents video frames from being dropped thus preventing jitter in the output media.

The foregoing and other features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a block diagram of a system that can incorporate embodiments of the invention.

FIG. 2 is a block diagram illustrating additional detail for the system of FIG. 1.

FIG. 3 is a functional block diagram illustrating one method of executing commands on the digital video processor of FIG. 1.

FIG. 4 is a block diagram illustrating a PVR system.

FIG. 5 is a diagram illustrating a buffer for use in the system illustrated in FIG. 4.

FIG. 6 is a diagram illustrating another buffer for use in the system illustrated in FIG. 4.

FIG. 7 is a block diagram of processors in the PVR system.

FIG. 8 is a block diagram comparing an improved object index table with a conventional object index.

FIG. 9 is a block diagram showing in more detail the improved object index table.

### DETAILED DESCRIPTION

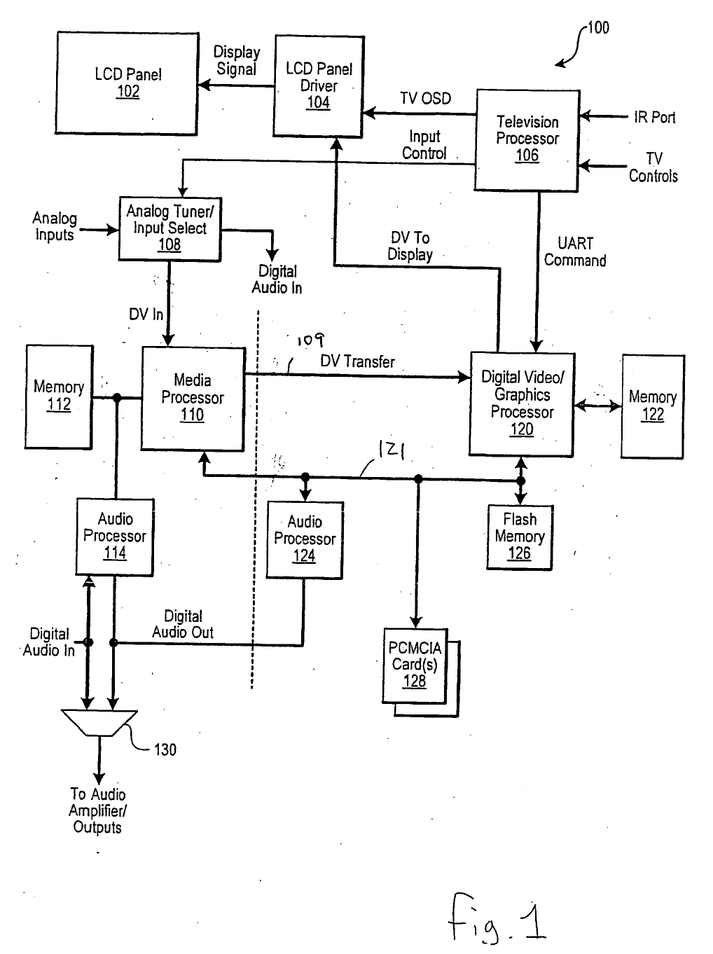

FIG. 1 is a block diagram for a Liquid Crystal Display (LCD) television capable of operating according to some embodiments of the present invention. A television (TV) 100 includes an LCD panel 102 to display visual output to a viewer based on a display signal generated by an LCD panel driver 104. The LCD panel driver 104 accepts a primary digital video signal, which may be in a CCIR656 format (eight bits per pixel YC_{b}Cᵣ, in a “4:2:2” data ratio wherein two C_{b} and two Cᵣ pixels are supplied for every four luminance pixels), from a digital video/graphics processor 120.

A television processor 106 (TV processor) provides basic control functions and viewer input interfaces for the television 100. The TV processor 106 receives viewer commands, both from buttons located on the television itself (TV controls) and from a handheld remote control unit (not shown) through its IR (Infra Red) Port. Based on the viewer commands, the TV processor 106 controls an analog tuner/input select section 108, and also supplies user inputs to a digital video/graphics processor 120 over a Universal Asynchronous Receiver/Transmitter (UART) command channel. The TV processor 106 is also capable of generating basic On-Screen Display (OSD) graphics, e.g., indicating which input is selected, the current audio volume setting, etc. The TV processor 106 supplies these OSD graphics as a TV OSD signal to the LCD panel driver 104 for overlay on the display signal.

The analog tuner/input select section 108 allows the television 100 to switch between various analog (or possibly digital) inputs for both video and audio. Video inputs can include a radio frequency (RF) signal carrying broadcast television, digital television, and/or high-definition television signals, NTSC video, S-Video, and/or RGB component video inputs, although various embodiments may not accept each of these signal types or may accept signals in other formats (such as PAL). The selected video input is converted to a digital data stream, DV In, in CCIR656 format and supplied to a media processor 110.

The analog tuner/input select section 108 also selects an audio source, digitizes that source if necessary, and supplies that digitized source as Digital Audio In to an Audio Processor 114 and a multiplexer 130. The audio source can be selected—independent of the current video source—as the audio channel(s) of a currently tuned RF television signal, stereophonic or monophonic audio connected to television 100 by audio jacks corresponding to a video input, or an internal microphone.

The media processor 110 and the digital video/graphics processor 120 (digital video processor) provide various digital feature capabilities for the television 100, as will be explained further in the specific embodiments below. In some embodiments, the processors 110 and 120 can be TMS320DM270 signal processors, available from Texas Instruments, Inc., Dallas, Tex. The digital video processor 120 functions as a master processor, and the media processor 110 functions as a slave processor. The media processor 110 supplies digital video, either corresponding to DV In or to a decoded media stream from another source, to the digital video/graphics processor 120 over a DV transfer bus.

The media processor 110 performs MPEG (Moving Picture Expert Group) coding and decoding of digital media streams for television 100, as instructed by the digital video processor 120. A 32-bit-wide data bus connects memory 112, e.g., two 16-bit-wide×1M synchronous DRAM devices connected in parallel, to processor 110. An audio processor 114 also connects to this data bus to provide audio coding and decoding for media streams handled by the media processor 110.

The digital video processor 120 coordinates (and/or implements) many of the digital features of the television 100. A 32-bit-wide data bus connects a memory 122, e.g., two 16-bit-wide×1M synchronous DRAM devices connected in parallel, to the processor 120. A 16-bit-wide system bus connects the digital video processor 120 to the media processor 110, an audio processor 124, flash memory 126, and removable PCMCIA cards 128. The flash memory 126 stores boot code, configuration data, executable code, and Java code for graphics applications, etc. PCMCIA cards 128 can provide extended media and/or application capability. The digital video processor 120 can pass data from the DV transfer bus to the LCD panel driver 104 as is, and/or processor 120 can also supercede, modify, or superimpose the DV Transfer signal with other content.

The multiplexer 130 provides audio output to the television amplifier and line outputs (not shown) from one of three sources. The first source is the current Digital Audio In stream from the analog tuner/input select section 108. The second and third sources are the Digital Audio Outputs of audio processors 114 and 124. These two outputs are tied to the same input of multiplexer 130, since each audio processor 114, 124, is capable of tri-stating its output when it is not selected. In some embodiments, the processors 114 and 124 can be TMS320VC5416 signal processors, available from Texas Instruments, Inc., Dallas, Tex.

As can be seen from FIG. 1, the TV 100 is broadly divided into three main parts, each controlled by a separate CPU. Of course, other architectures are possible, and FIG. 1 only illustrates an example architecture. Broadly stated, and without listing all of the particular processor functions, the television processor 106 controls the television functions, such as changing channels, changing listening volume, brightness, and contrast, etc. The media processor 110 encodes audio and video (AV) input from whatever format it is received into one used elsewhere in the TV 100. Discussion of different formats appears below. The digital video processor 120 is responsible for decoding the previously encoded AV signals, which converts them into a signal that can be used by the panel driver 104 to display on the LCD panel 102.

In addition to decoding the previously encoded signals, the digital video processor 120 is responsible for accessing the PCMCIA based media 128, as described in detail below. Other duties of the digital video processor 120 include communicating with the television processor 106, and acting as the master of the PVR operation. As described above, the media processor 110 is a slave on the processor 120's bus. By using the two processors 110 and 120, the TV 100 can perform PVR operations. The digital video processor 120 can access the memory 112, which is directly connected to the media processor 110, in addition to accessing its own memory 122. Of course, the two processors 110, 120 can send and receive messages to and from one another.

To provide PVR functions, such as record, pause, rewind, playback, etc, the digital video processor 120 stores Audio Video (AV) files on removable media. In one embodiment, the removable media is hosted on or within a PCMCIA card. Many PVR functions are known in the prior art, such as described in U.S. Pat. Nos. 6,233,389 and 6,327,418, assigned to TIVO, Inc., and which are hereby incorporated herein by reference.

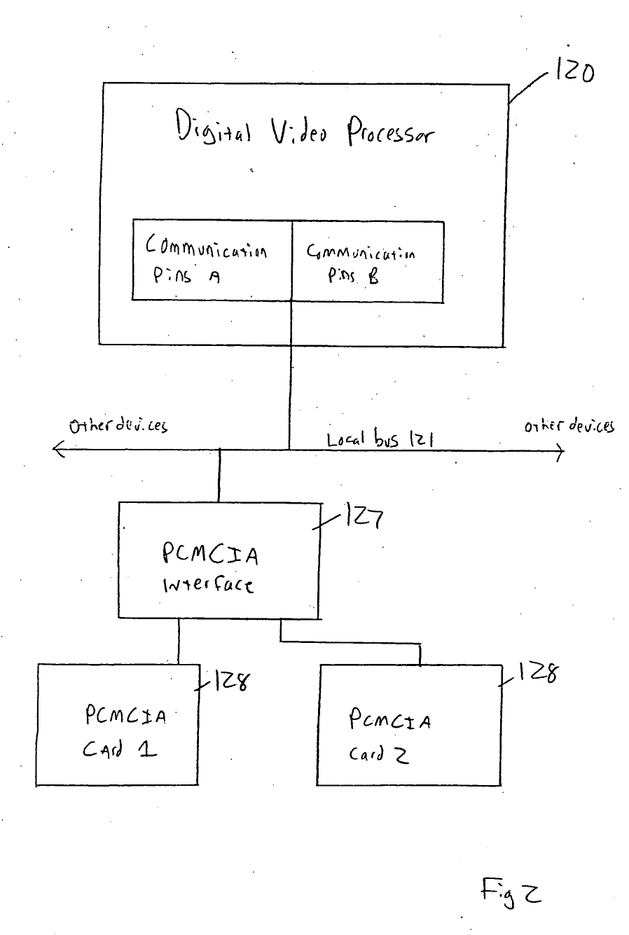

FIG. 2 illustrates additional details of the TV 100 of FIG. 1. Specifically, connected to the digital video processor is the processor 120's local bus 121. Coupled to the local bus 121 is a PCMCIA interface 127, which is a conduit between PCMCIA cards 128 and the digital video processor 120. The interface 127 logically and physically connects any PCMCIA cards 128 to the digital video processor 120. In particular, the interface 127 may contain data and line buffers so that PCMCIA cards 128 can communicate with the digital video processor 120, even though operating voltages may be dissimilar, as is known in the art. Additionally, debouncing circuits may be used in the interface 127 to prevent data and communication errors when the PCMCIA cards 128 are inserted or removed from the interface 127. Additional discussion of communication between the digital video processor 120 and the PCMCIA cards 128 appears below.

A PCMCIA card is a type of removable media card that can be connected to a personal computer, television, or other electronic device. Various card formats are defined in the PC Card standard release 8.0, by the Personal Computer Memory Card International Association, which is hereby incorporated by reference. The PCMCIA specifications define three physical sizes of PCMCIA (or PC) cards: Type I, Type II, and Type III. Additionally, cards related to PC cards include SmartMedia cards and Compact Flash cards.

Type I PC cards typically include memory enhancements, such as RAM, flash memory, one-time-programming (OTP) memory and Electronically Erasable Programmable Memory (EEPROM). Type II PC cards generally include I/O functions, such as modems, LAN connections, and host communications. Type III PC cards may include rotating media (disks) or radio communication devices (wireless).

Embodiments of the invention can work with all forms of storage and removable media, no matter what form it may come in or how it may connect to the TV 100, although some types of media are better suited for particular storage functions. For instance, files may be stored on and retrieved from Flash memory cards as part of the PVR functions. However, because of the limited number of times Flash memory can be safely written to, they may not be the best choice for repeated PVR functions. In other words, while it may be possible to store compressed AV data on a flash memory card, doing so on a continual basis may lead to eventual failure of the memory card well before other types of media would fail.

Referring back to FIG. 1, to perform PVR functions, a video and audio input is encoded by the media processor 110 and stored in the memory 112, which is located on the local bus of the media processor 110. Various encoding techniques could be used, including any of the MPEG 1, 2, 4, or 7 techniques, which can be found in documents ISO/i 172, ISO/13818, ISO/14496, and ISO/15938, respectively, all of which are herein incorporated by reference. Once encoded, the media processor 110 may store the encoded video and audio in any acceptable format. Once such format is Advanced Systems Format (ASF), by Microsoft, Inc. in Redmond Wash.

The ASF format is an extensible file format designed to store synchronized multimedia data. Audio and/or Video content that was compressed by an encoder or encoder/decoder (codec), such as the MPEG encoding functions provided by the media processor 110 described above, can be stored in an ASF file and played back with a Windows Media Player or other player adapted to play back such files. The current specification of ASF is entitled “Revision 01.20.01e”, by Microsoft Corporation, September, 2003, and is hereby incorporated herein by reference. Additionally, two patents assigned to Microsoft, Inc., and specifically related to media streams, U.S. Pat. No. 6,415,326, and U.S. Pat. No. 6,463,486, are also hereby incorporated by reference.

Once the media processor 110 encodes the AV signals, which may include formatting them into an ASF file, the media processor 110 sends a message to the digital video processor 120 that encoded data is waiting to be transferred to the removable storage (e.g., the PCMCIA media 128). After the digital video processor 120 receives the message, it reads the encoded data from the memory 112. Once read, the digital video processor 120 stores the data to the PCMCIA media 128. The digital video processor 120 then notifies the media processor 110 that the data has been stored on the PCMCIA media 128. This completes the encoding operation.

Outputting AV signals that had been previously stored on the removable media begins by the digital video processor 120 accessing the data from the media. Once accessed, the data is read from the PCMCIA card 128 and stored in the memory 122 connected to the digital video processor 120 (FIG. 1) The digital video processor 120 then reads the data from the memory 122 and decodes it. Time shifting functions of the PVR are supported by random access to the PCMCIA card.

In addition to time shifted AV viewing, real-time AV can also be displayed in this TV 100 system. To view real-time AV, video signals pass through the media processor 110 and into the digital video processor 120. The digital video processor 120 can overlay graphics on the video, as described above, and then output the composite image to the panel driver 104. Graphics overlay is also supported during PVR playback operation. The graphics are simply overlaid on the video signal after it has been decoded by the digital video processor 120.

Interaction with the PCMCIA Card

As many signals are used both for the A slot and the B slot, additional signals and logic are used to select and activate each slot. For instance, the digital video processor 120 may be writing to one of the PCMCIA cards 128 while reading from another. As mentioned above, having two PCMCIA slots in the interface 127 (FIG. 2) is only illustrative, and any number of slots may be present in the TV 100. Accommodating additional PCMCIA cards 128 in the TV 100 (FIG. 1) may require additional digital video processors 120, however.

The particular type of media in the PCMCIA slot can be detected using methods described in the PC Card standard. The standard allows for the distinction between solid state media and rotating disk media. Solid state media often has a limited number of read and write cycles before the media is no longer fully functional, while rotating disk media has a much longer life cycle. By detecting the type of media, the TV system 100 can determine if the media is suitable for PVR operation. Particular TV systems 100 may, for instance, prohibit PVR functions if only solid state media PCMCIA cards are mounted in the interface 127.

Optimally, newly formatted data is used for the PVR operation. This improves PVR performance by reducing media fragmentation. In operation, a data storage file is created on the media on the PCMCIA card 128 when PVR is first enabled. This allows a contiguous File Allocation Table (FAT) sector chain to be created on the media, improving overall performance. Optimally, the file remains on the disk even when PVR operation is disabled on the TV system 100, such that the media allocation is immediately available, and contiguous for future PVR operations. The file size on the PCMCIA media can be a function of a desired minimal size, the amount of room currently available on the media, the total amount of storage capacity of the media, or other factors. The file size and the encoded AV bit rate by the media processor 110 determine the amount of time shift possible. A circular file may be used, containing data similar to that described in the ASF standards, described above, for optimal media utilization.

Performing PVR Functions

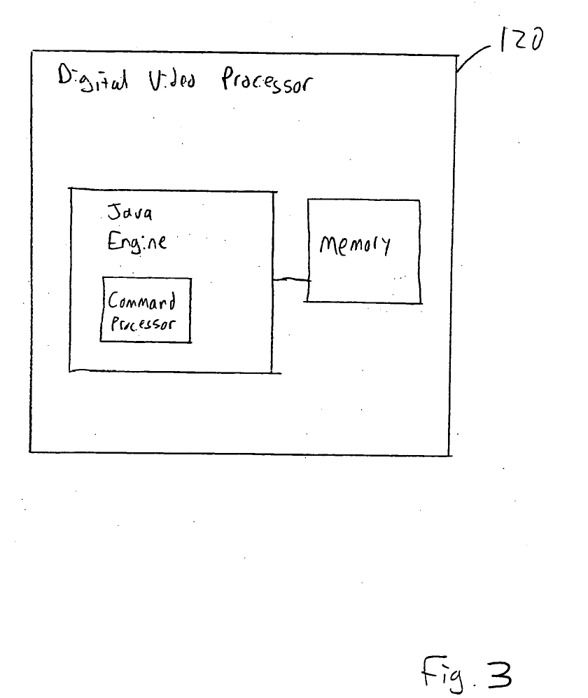

PVR functions can be performed by generating proper signals to control functions for the PCMCIA cards. In one embodiment, the digital processor 120 can include a java engine, as illustrated in FIG. 3. The java engine can perform particularized java functions when directed to, such as when an operator of the TV 100 (FIG. 1) operates a remote control, or when directed by other components of the TV system 100 to control particular operations.

For instance, an operator may indicate that he or she would like a particular show recorded.

Additionally, at the operator's convenience, the operator may select a previously recorded show for playback. Some of the commands that the java engine of FIG. 3 can perform are listed in table 1, below.

Table 1:

Function
Get current media mode
Set current media mode
Load media mode
Begin PVR recording/playback
End PVR recording
Begin PVR recording to a selected file
Begin PVR playback of a selected file
Pause playback of the currently played PVR file
Resume playback of the currently played PVR file
Skip ahead or backwards in the current PVR file by a requested number of seconds
Jump to live video during PVR mode
Stop recording currently active PVR file
Stop playback of currently active PVR play file
Set fast playback speed of currently active PVR playback file to speed factor
Set fast playback speed of currently active PVR playback file to the inverse of factor

PVR Functions and Playback Modes

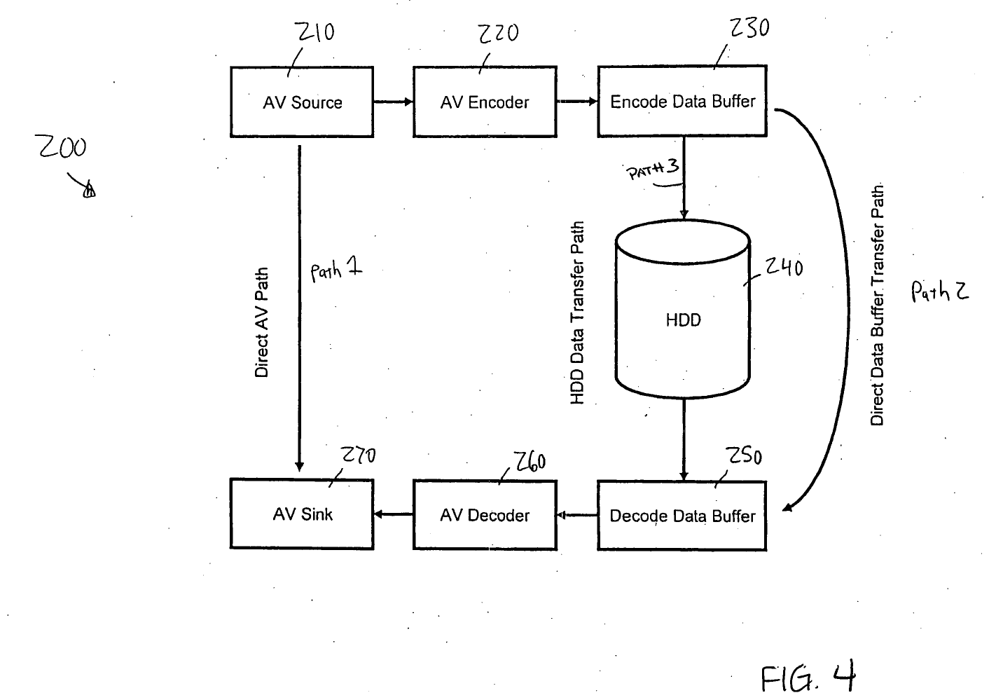

FIG. 4 is a functional diagram of a PVR system 200 that can operate on the TV 100 illustrated in FIG. 1. FIG. 4 also indicates different paths that an Audio/Video (AV) media stream can proceed through the system. The PVR system 200 of FIG. 4 includes several component parts, such as an AV input 210, an AV encoder 220, an encode data buffer 230, a hard disk drive (HDD) or other media on which encoded video can be stored 240, a decoding data buffer 250, an AV decoder 260, and an AV sink, or video output 270.

Many of these functions illustrated in FIG. 4 can correspond neatly to components illustrated in FIG. 1. For example, the AV input 210 can be the video and audio signals that are fed to the media processor 110. The encoder 220 can be tasks, programs, or procedures operating on the media processor 110.

The encode data buffer 230 could be memory storage locations in memory 112, which is controlled by the media processor 110 and can be accessed by the digital video processor 120. Further, the HDD or other media 240 can be embodied by rotating storage media or other types of storage media such as the PCMCIA cards 128, described above. Although they may be referred to herein as the HDD 240, it is understood that such a reference includes all types of storage media.

The decode data buffer 250 can be implemented by the memory 122 that is connected to the digital video processor 120. The AV decoder 260 can be implemented by tasks, procedures, or programs running on the processor 120. Finally, the video sink/output 270 can be implemented by the LCD panel driver 104, which combines any on screen display messages from the TV processor 106 with the digital video before sending them to the LCD panel 102.

The AV signals can travel through the PVR system 200 of FIG. 4 using any one of three different paths. The first, which will be called path 1, is directly from the video source 210 to the video output 270. With reference to FIG. 1, path 1 can be accomplished by transmitting the DV signal 109 directly from the media processor 110 to the digital video processor 120, which is further transferred by processor 120 to the panel driver 104 for output. Path 1 can be executed with very little delay, on the order of one or two frames difference between the time the video signal is input to the media processor 110 until the same signal is output on the LCD panel 102. Frames are usually generated at around 32 frames/second.

Path 2 begins from the video input 210, through the AV encoder 220 and into the encode buffer 230. From the encode buffer 230, path 2 travels directly to the decode data buffer 250, bypassing the HDD 240. After the signal reaches the decode data buffer 250, it is transmitted through the AV decoder 260 to the AV sink 270.

With reference to FIG. 1, path 2 can be implemented by first providing the AV signals to the media processor 110, which encodes the signals as described above. For instance, the media processor 110 can encode video and audio segments and multiplex (mux) them together into an ASF file, along with time stamps, and store them in the memory 112. Next, the digital video processor 120 can read and decode the stored file.

The video processor 120 may store the data read from the memory 112 internally. For example, the local memory within the processor 120 may be used as the decode data buffer 250. In another embodiment, the processor 120 transfers the encoded data from the memory 112 to memory 122 before decoding. In this case, the memory 122 is used as the decode data buffer 250. The video processor 120 decodes the previously encoded data, which includes de-multiplexing the video and audio streams from one another. Once separated, the video stream is sent to the LCD panel driver 104 while the audio signal can be sent to the audio processor 124, to be amplified and played from speakers.

Path 3 is similar to path 2, however, data is stored on the HDD 240 indefinitely. This allows the time shifting component to the PVR 200. With reference to FIG. 1, after the media processor 110 encodes the AV stream and stores it into the memory 112, the digital video processor 120 moves the data from the memory 112 to be stored on one or more PCMCIA cards 128, as described above. Then the digital video processor 120 sends a message to the media processor 110 that the data has been stored, and can be overwritten in the memory 112. Keeping track of data in both the encode data buffer 230 and what is on the HDD 240 can be performed by one or more circular buffers, as described below.

With respect to differences between the paths, true real-time video traverses path 1. This video is the highest fidelity, with little or no latency. Time shifted video can traverse path 2 or path 3. This video is generally lower fidelity, due to the lossy AV encoder and AV decoder, but allows time shifting.

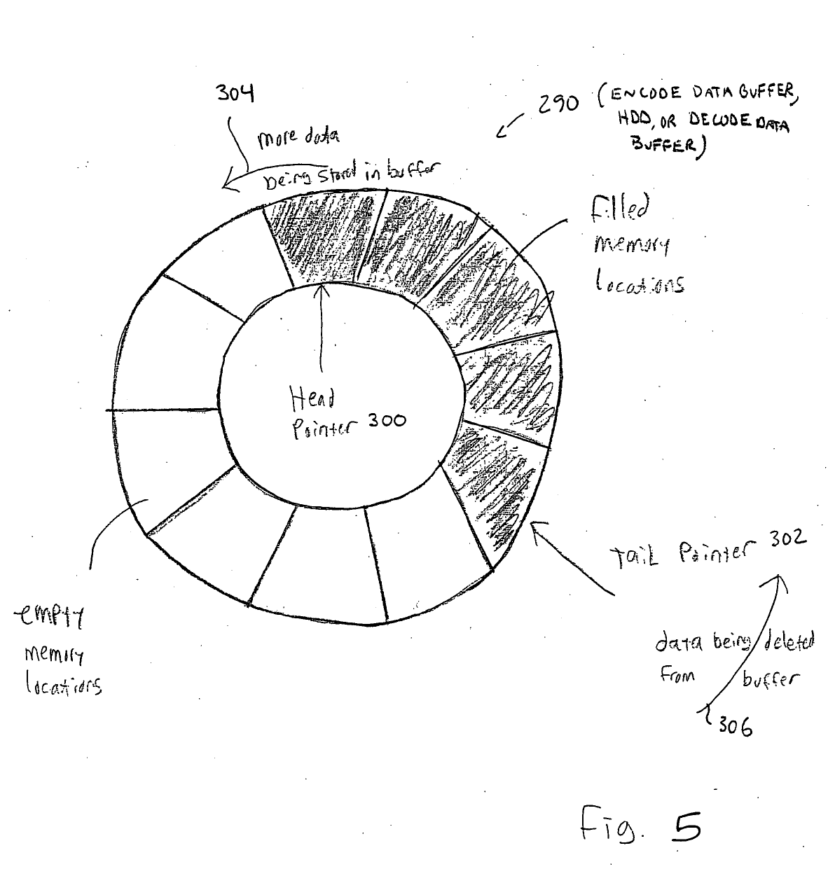

Referring to FIG. 5, each storage device can use a circular or other type of buffer 290 to keep track of data stored within it. Each buffer 290 has an associated head pointer 300 and tail pointer 302 indicating where data is stored. The circular buffer 290 in FIG. 5 is shown in a circular shape for explanation purposes. The buffer 290 is typically not circular in shape as shown in FIG. 5, but is illustrated in a circular shape to show how data is circulated into and out of the buffer 290.

The head pointer 300 is incremented as data 304 is stored in the storage device 290 and the tail pointer 302 is incremented as data 306 is read from the device 290. When the head pointer 300 and the tail pointer 302 are equal, no data is in the storage device 290. Each device 290 is preferably a circular buffer, such that head pointer 300 and the tail pointer 302 may wrap around. This reduces the amount of required storage room. The sum of all circular buffer lengths, combined with the encoded AV bit rate, determines the total amount of time shift possible.

Referring to FIGS. 4 and 5, when the PVR 200 is turned on, video is continuously encoded, buffered, and then stored to the HDD 240. Data storage is independent of the current time shift of the displayed video. The head pointer 300 for the encode buffer 230 indicates where the next data will be written in the encode data buffer 230. This head pointer 300 is updated every time the AV encoder 220 writes data 304 into the encode data buffer 230.

The tail pointer 302 for the encode buffer 230 indicates where the next data 306 will be read from the encoded data buffer 230 for storage into the HDD 240. Tail pointer 302 is updated every time data 306 is read from the encode data buffer 230 and written into the HDD 240.

Another head pointer 300 may be used for the HDD 240 and indicates where the next data will be written to the HDD 240. The head pointer 300 is updated every time data 304 is written to the HDD 240. Similarly, the tail pointer 302 is updated every time data 306 is read out of HDD 240. A similar head pointer 300 and tail pointer 302 can operate for the decode data buffer 250.

As described above, when real-time video is displayed, the video follows path 1 in FIG. 4. The AV encoder 220, encode data buffer 230, HDD 240, decode data buffer 250, AV decoder 260 and other components may be bypassed. Although, the video may still at the same time be encoded and stored in HDD 240.

When time shifted video is displayed, the video stream follows either path 2 or path 3, depending upon the amount of time shift desired. In either case, the video is generated by decoding data in the decode data buffer 250. The difference between path 2 and path 3 is the source of the data being stored in the decode data buffer 250. If the requested time shift is so small that the video data has not yet been stored to the HDD 240, the data is written into the decode data buffer 250 directly from the encode data buffer 230. However, when the requested time shift is large enough that the video data has already been stored onto the HDD 240, the data is written into the decode data buffer 250 from the HDD 240.

The head pointer for the decode buffer 250 indicates where the next video data written into the decode data buffer 250 will be read from. This head pointer is updated every time data is written into the decode data buffer 250. The tail pointer for the decode buffer 250 indicates where the next data will be read from the decode data buffer 250 for decoding by the AV decoder 260. This tail pointer is updated every time data in decode data buffer 250 is read by the AV decoder 260.

When data from the HDD 240 is being decoded, the tail pointer 302 for the HDD 240 indicates where the next data will be read from the HDD 240. This tail pointer 302 is updated after data is read from the HDD 240 and written into the decode data buffer 250. When the HDD tail pointer 302 equals the HDD head pointer 300, no new data is available on the HDD 240. In this case, the decode data buffer 250 is filled with data from the encode data buffer 230.

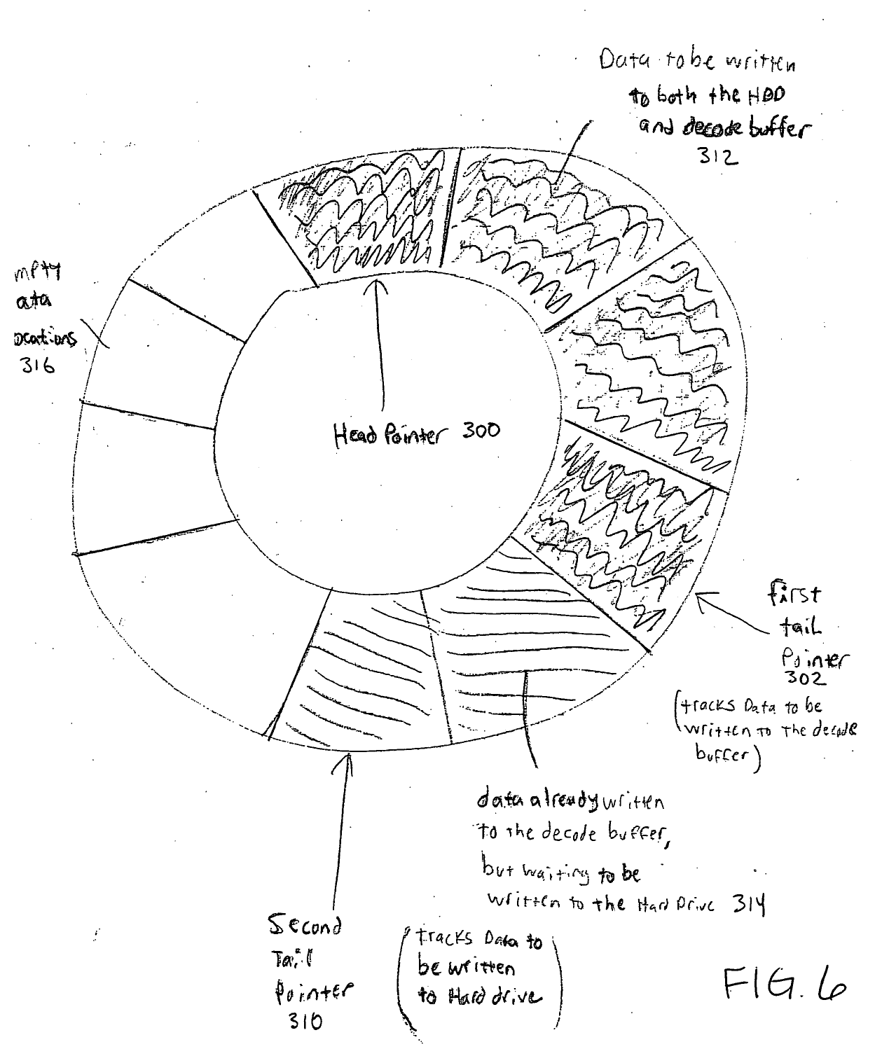

Referring to FIG. 6, when filling the decode data buffer 250 with data from the encode data buffer 230, a second encode data buffer tail pointer 310 may be used. The encode data buffer 230 has two types of data. Data 312 still needs to be written to both the HDD 240 and to the decode data buffer 250. Data 314 has already been written into the decode data buffer 250 but is still waiting to be written into the HDD 240. Buffer locations 316 are empty.

The first tail pointer 302 indicates where the next data in the encode data buffer 230 will be read for storing into the decode data buffer 250. The second tail pointer 310 indicates where the next data will be read from the encode data buffer 230 for storing in the HDD 240. The first tail pointer 310 is updated every time encoded data is written from the encode data buffer 230 and stored in the decode data buffer 250. The second tail pointer 310 is updated every time encoded data is written from the encode data buffer 230 and stored in the HDD 240.

The PVR system 200 uses the various pointers to keep the decode data buffer 250 filled with the desired encoded data. When the user of the TV system 100 (FIG. 1) requests time shifting, the PVR system 200 determines which data source (HDD 240 or encode data buffer 230) to read from, calculates the read location, and copies the necessary data into the decode data buffer 250.

For example, if the requested time shift is so small that the video data has not yet been stored to the HDD 240, the data is written into the decode data buffer 250 directly from the encode data buffer 230 (Path 2). The first tail pointer 302 for the encode data buffer 230 tracks the next media in the encode data buffer 230 to be written into the decode data buffer 250 during the small time-shit situation. The second tail pointer 310 tracks the next media in the encode data buffer 230 to be written to the HDD 240.

When the requested time shift is large enough that the video data has already been stored onto the HDD 240, the data is written into the decode data buffer 250 from the HDD 240 (Path 3). In this situation, the encode data buffer 230 only writes data into the HDD 240 and therefore may only need one tail pointer 310 to identify the next media for writing into HDD 240.

The calculation mechanism is dependent upon the type of data encoded and the data bit rate. For example, a rough MPEG2 calculation can be made simply using the transport stream's average data rate. More precise calculations can be made using the group of pictures (GOP) descriptor. ASF files can be calculated using their associated object index information.

Using the multiple AV paths and the ability to correctly access all data storage buffers described above, it is possible to construct a PVR which also allows high fidelity, zero latency real-time video display in addition to standard time shifted PVR AV display.

Using the system described above, a PVR can be designed using PCMCIA base media, thus supporting easy media removal and replacement, and multiple media formats, and multiple playback modes.

Real-Time Timestamp Generation for Keeping Video and Audio in Sync for Trick Mode

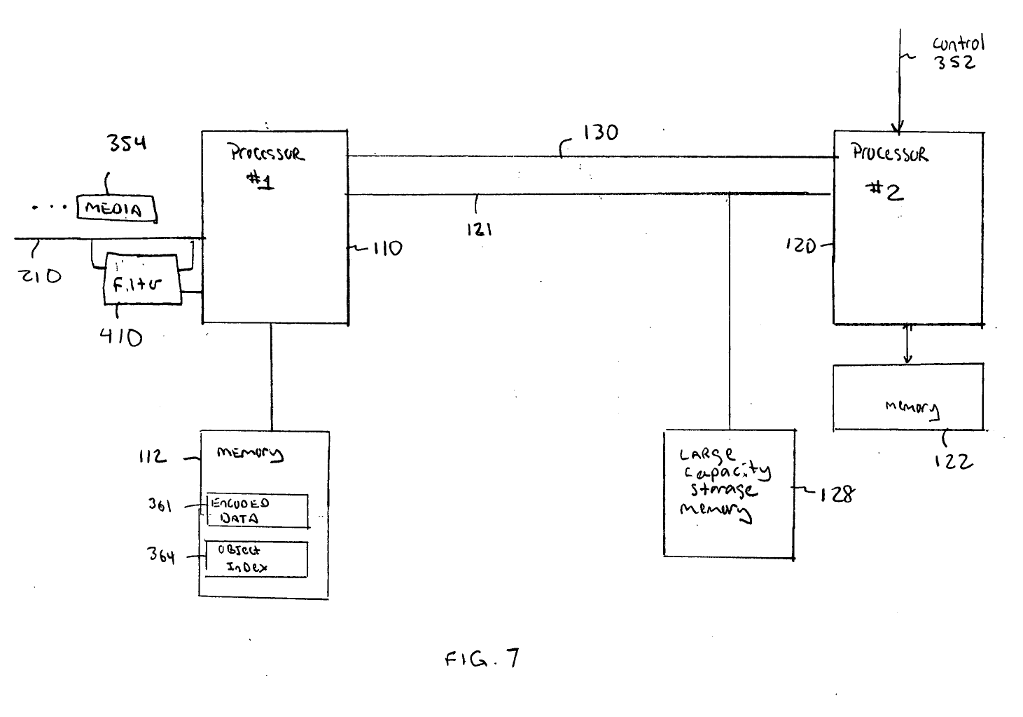

FIG. 7 shows an isolated view of the media processor 110 and the digital video processor 120 previously shown in FIG. 1. The processor 110 receives media, such as audio and video, from a media source 210. The un-encoded media can be transferred from processor 110 to processor 120 over bus 130. A bus 121 is used to transfer commands and encoded media between processor 110 and processor 120. The processor 110 and the processor 120 can each access memory 112. Processor 120 can also access memory 122 and large capacity storage memory 128, which in one example is a PC card.

Processor 120 is controlled for different video and audio operations through control signals 352. Processor 120 in turn controls processor 110 via commands sent over bus 121. In one example, the control signals are generated by the television processor 106 in FIG. 1. The type of user control operations that will be described below may include different types of audio or video (media) manipulation operations referred to generally as trick-modes. For example, some of the trick-mode operations that may be requested over control line 352 may include:

1. Skip back

2. Skip forward

3. Fast forward

4. Rewind

5. Pause

6. Slow play

7. Search

8. Skip too far back detection and prevention

9. Automatic jump forward to live video when skip forward is selected too far ahead

The above specified operations are only examples and other media manipulation operations or trick-modes can also be implemented.

A media stream 354 is encoded by the processor 110. Once encoded, the media processor 110 may store the encoded video and audio in any acceptable format, such as the Advanced Systems Format (ASF), by Microsoft, Inc. in Redmond Wash. The ASF format is an extensible file format designed to store synchronized multimedia data. Audio and/or Video content that was compressed by an encoder or encoder/decoder (codec), such as the MPEG encoding functions provided by the media processor 110 described above, can be stored in an ASF file and played back with a Windows Media Player or other player adapted to play back such files. The current specification of ASF is entitled “Revision 01.20.01e”, by Microsoft Corporation, September, 2003, and is hereby incorporated herein by reference.

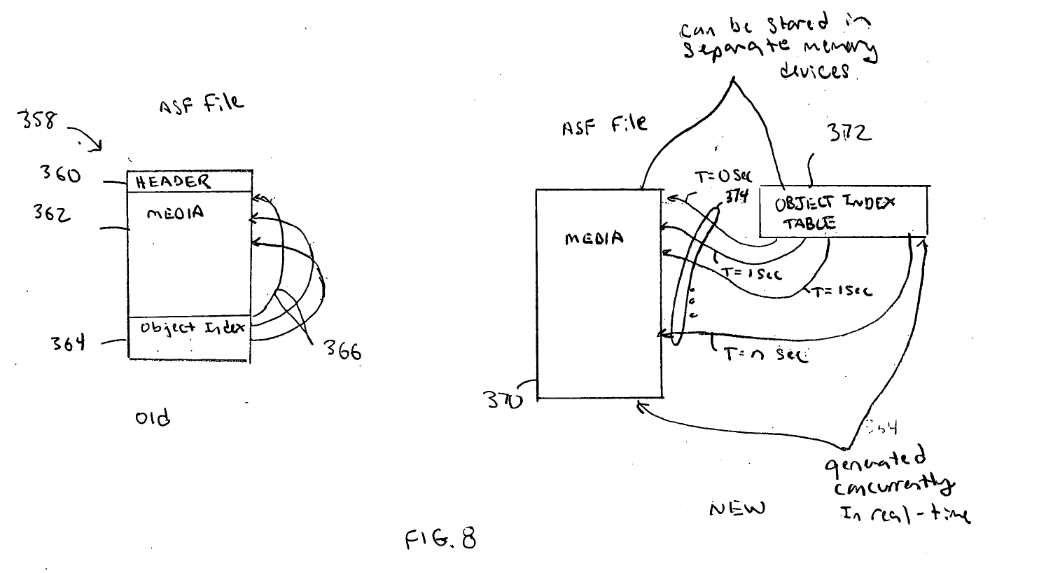

In FIG. 8, a conventional ASF file 358 includes a header 360, ASF formatted media 362 and an object index 364. The object index 364 is attached to the end of the ASF file 358 and contains pointers 366 into the media 362 of the ASF file 358. The object index 364 is generated after a complete media file 358 has been received. For example, in a conventional system a user may record some media and then press stop to stop recording. The conventional ASF system encodes the media and stores it on a HDD device. The object index 364 is not created until the user stops the recording operation. The object index table 364 is then generated for the already encoded ASF formatted media and stored along with the media in the HDD device. This process does not work with streaming media where certain operations have to be performed on the media while it is still being generated.

Real-Time Trick-Mode

The processor 110 in one embodiment generates an object index table 372 at the same time (concurrently) the media 370 is being encoded and stored in the ASF format. In one example, the pointers 374 are generated in real time for each one second of video and audio 370. This is different from conventional ASF files that generate the object index 364 only after the media 362 has been formatted into the ASF file in the HDD device 240 (FIG. 4). This allows video play back without the user having to stop the video recording session. Secondly, it allows playback of media in the memory 112 (FIG. 1) before it has been encoded and stored in the HDD 240.

When a user requests a trick-mode, such as a fast forward, skip, or rewind; the processor 120 knows the current encoding time (current real time) and knows the last media that has been encoded and stored in memory 112. The processor 110 can go into the ASF file 370 the number of index locations 374 that correspond with the time shift associate with the user's trick mode request.

For example, a user may request rewinding the displayed video back 7 seconds. The processor identifies a current time using an internal clock and looks into the object index table 372 to identify the index 374 associated with 7 seconds earlier. For example, with one second per index location, the object index table 372 is used to identify the media location that has an index value 7 more than the last media decoded by the decoder 260. The processor 120 then starts playing out the media from the identified index location.

The media location identified by the pointer 374 in object index table 372 may be located in memory 112. However, if the requested amount of video to rewind is large enough, the pointer in the index table 372 may point to media in the large capacity storage memory 240. For example, the processor 110 may encode and store media in an encode data buffer 230 located in the memory 112 as shown in FIG. 4. As the encode data buffer 230 fills up, the oldest encoded media is stored in the HDD 240 (FIG. 4). Thus, if the requested rewind is far enough back in time, the pointer in the object index table 372 may point to encoded data in the HDD 240. Storing the object index table 372 in Random Access Memory (RAM) 112 instead of in the HDD 240 allows the object index table 372 to be continuously updated in real-time.

The processor 110 may circulate the media through the encode data buffer 230 in memory 112 using the circular buffer as shown in FIGS. 5 and 6. As described above, the circular buffers in FIGS. 5 and 6 are used to identify what media is currently in the encode data buffer 230, the HDD 240, and the decode data buffer 250.

Skip Mode

Skip back and skip forward modes use the object index table 372 described above to identify where the processor 120 has to jump to in the buffers 230, 250 and in storage device 240 in order to start playing out the requested media. The skip mode can detect and prevent a user from skipping too far back or too far ahead. For example, the HDD 240 may only be able to store 30 minutes of encoded media. If a user requests a skip back 40 minutes, the processor 120 may only allow the maximum 30 minutes of skip back. In this example, the processor 120 would identify the index for the oldest stored media, and start playing the media from the identified oldest index.

In the skip back and skip forward modes, the processor 120 may sum up or accumulate the number of times the user presses the skip back and/or skip forward buttons. Instead of skipping back or forward once for each button press, the processor 120 may accumulate the total number of skips and then perform one skip that encompasses the accumulated total skip requests. If the user happens to make several skip back requests and also makes some skip forward requests, the processor 120 may subtract the opposite skip requests from the accumulated total before displaying the frame associated with the accumulated number of skip requests. The processor 120 may accumulate requests up until the time an earlier request has been completed. Other operations that may be initiated after a skip command, such as a pause command, would cause an immediate accumulation of all of the skip commands up to the point where the pause command was selected. In an alternative embodiment, all skips detected within some predetermined time period of each other are accumulated (added together and/or subtracted). If another non-skip command, or no command is then received within some predetermined time period, the accumulated skip value is determined by processor 120 and the corresponding pointer 374 used to locate the location in media 370 where the media will start being played out.

An automatic jump forward to live video mode is activated when the user requests a skip forward that is too far ahead. When the skip forward commands get within a few frames of the currently encoded media frame, the processor 120 may automatically start displaying real-time live video as described above in FIG. 4. For example, the input media source 210 may be fed directly into the output 270 (FIG. 4) without first being encoded, stored and decoded.

Fast Forward & Rewind Mode

The fast forward mode and rewind mode can both be based on the object index table 372. A user may request fast forward at 8 times the normal display rate. The fast forward is then based upon an actual time associated with when the user actually pressed the rewind or fast forward button. One of the processors may measure the actual time when a user first presses the fast forward button and then identify the time stamp for the media associated with that time. The processor then detects the amount of time the user presses the fast forward button and multiplies that time duration by 8. The video is then fast forwarded from the current media location relative to where the user first pressed the fast forward button to the index 374 associated with the derived time duration.

If a rewind operation goes back to a point where there is no more media located in the HDD for rewinding, the system goes into a resume mode where it starts encoding and decoding data at a normal display rate.

Pause & Slow Play Mode

The pause operation maintains displaying a current video image. At the same time the encoder 220 (FIG. 4) may continue to encode media and store the media in encode data buffer 230. If the pause operation is activated for too long, the encoder 220 may come close to catching up with the decoder 260. In this situation, the processors 110 and 120 automatically to go back into a resume mode that encodes and decodes media at a normal display rate.

The slow play operation causes the decoder 260 to output video at a slower than normal rate. If the slow play operation is activated long enough where the encoder 220 starts to catch up with the decoder 260, the system may also automatically go back into the resume mode. The search operation is used for searching for a particular character, item or frame in the media.

Thus the object index table 372 is generated in real time inside of the memory 112 separate from the large capacity storage memory 128 (FIG. 7) that stores the encoded media. The object index table 372 in one embodiment is operated as a circular mode and allows the television system to provide more media trick features than present video display systems.

Rate Control

Referring back to FIG. 7, processor 110 is the media encoding processor that encodes media 354 into encoded data 361 and also generates an associated object index 364. In one example, processor 120 may read the encoded data 361 and object index values 364 from memory 112 and then write the encoded data 361 from memory 112 into main memory 128.

Depending on the amount of required time shift associated with a trick-mode operation, the processor 120 may need to read encoded data 361 directly from memory 112 (relatively short time shift) or from large capacity storage memory 128 (relatively large time shift). If no time shifting is currently required (i.e., no trick mode currently requested by the user), then the processor 110 may pass through the media 354 in real-time directly to processor 120 over bus 130. At the same time, the processor 110 also continuously encodes and stores the same media 354 in memory 112. This is required for any later received trick-mode request from the user that requires the processor 120 to reference back to previously output media.

There may be situations where there may not be enough bus bandwidth for processor 120 to both read encoded media 361 out of memory 112 and write the encoded media 361 into memory 128 and at the same time read the time shifted encoded data out of memory 128 for decoding and outputting to a display unit. For example, a current displayed image may be paused for 10 seconds, or a relatively long rewind operation may be requested. The encoded media following the pause or rewind operation may all reside in the main memory 128 when normal display operations are resumed. In this situation, there may be a log jam of media in the memory 128 that still needs to be decoded after the pause or rewind operation. This log jam may prevent the encoder 220 (FIG. 4) from being able to store additional encoded media in memory 128. For example in FIG. 7, this bandwidth logjam for memory 128 may prevent processor 120 from transferring all of the required encoded data 361 in memory 112 into memory 128 and at the same time reading all of the required time shifted media out of memory 128 for outputting to a display unit.

To prevent the encoder 220 from having to drop video frames, the decoder 260 of the processor 120 responsible for outputting video may go into a slow down rate where video frames are updated on the display at a slower rate. For example, the displayed video may only be updated once ever other second instead of once every second. Or media may only be displayed every ⅛^{th} second frame instead of every 1/16^{th} second frame. This allows the decoder 260 (processor 120) to be idle every other frame. This gives the processor 120 time to move more encoded media 361 from memory 112 into the main memory 128.

In another embodiment, the encoder 220 in the processor 110 may alternatively or in addition, vary the rate that it is encoding the incoming media 354 so that less encoded media 361 has to be transferred by processor 120 from memory 112 to memory 128. For example, a lower sample rate may be used to encode the video image, which then results in less encoded video data per frame.

The output image update rate or the encoding resolution sample rate can be dynamically varied according to the amount of media in the encode data buffer 230 that needs to be stored in the memory 240 (FIG. 4) or the amount of media in the decode buffer 250 that needs to be decoded.

So for example, a rewind operation may cause the processor 120 to start reading media in a previous location in HDD 240. This forces the decoder 260 to start decoding all the media in HDD 240 from the rewind location. This also causes the encode data buffer 230 to start backing up with new encoded media. If the amount of encoded media in encode data buffer 230 rises above some threshold value, either the displayed image is updated less frequently or the encoded image rate output from the encoder 220 is reduced, until the encoded data in the encode data buffer 230 falls back below the threshold level.

Referring back to FIG. 7, in another embodiment, a filter 410 may be used to reduce the data rate that media is received by the processor 110. The filter 410 might be coupled between the media source 210 and the processor 110. In an alternative embodiment, the processor 110 may implement the filter 410.

The filter 410 is adjusted to reduce the bit rate of received media according to different encoding and skip-mode situations. For example, there may be situations where encoded data is received at a higher rate than normal. Such as when panning is being performed in the video image or when there is a lot of noise in the video source. The panning and noise conditions reduce the amount of compression that can be performed by the encoder 220 (FIG. 4). Thus, the processor 110 may start filling up the encode data buffer 230 at a faster rate than can be handled in the HDD 240. Media backup in the encode data buffer 230 can also be caused by the trick-mode operations described above that may cause the decode data buffer 250 to become so busy that the encode data buffer 230 has reduced access to the HDD 240.

The hardware filter 410 can be implemented to have different states, such as off, medium and high. When the bit rate for the media is at an acceptable level that can be handled by the encode data buffer 230 and HDD 240, the hardware filter 410 may be turned off. In this case, the media is encoded at a normal rate. At the medium rate, the hardware filter 410 may reduce the resolution of the image that is sampled for encoding. For example, a higher quantization may be performed. If the bit rate of the data encoded by encoder 220 is very high, then the filter 410 may operate at an even coarser sampling rate to maintain a substantially constant bit rate into the encode data buffer 230.

This prevents the encode data buffer 230 from overflowing while waiting to store media in HDD 240. The filter 410 can be a separate analog or digital device that includes software that provides the different filter levels or can be additional software that is operated by the processor 110.

The video frame in the high filter mode may have a coarser resolution. However, this is still better than dropping video frames, which visually cause jerky disjointed movements to appear on the video display. The filter mode also maintains the audio in the correct continuous sequence which is less noticeable than a break in the audio caused by a skipped video frame.

The same filtering operation can be performed by the decoder 260. For example, the media may have a lot of errors that require more error correction by the decoder 260. This slows down the output bit rate of the decoder 260 causing media in data buffer 250 to back up. If the decoder 260 gets backed up, the decoder 260 may decode the video at a coarser lower resolution for example by increasing the quantization of the encoded media decoded in the decode data buffer 250.

Different trigger modes can be used in the encode data buffer 230 and decode data buffer 250 so that a certain amount of back up in a particular buffer activates a first level of filtering, a second amount of media backup activates a next level of filtering, etc. The two buffers 230 and 250 can each have different threshold levels and associated filtering rates.

Time Shift Display

The processors 110 or 120 can measure an amount of time shift and notify a user how far back or forward in time they have requested. The processor 120 for example can calculate the time shift by comparing the selected encode time with the selected or current decode time. The processor 120 can also measure the difference between the decode time and the end of the media file in HDD 240 and identify this to the user. This tells the user how much time is left in the media file. Thus, the processor 120 can tell a user how much more time they can fast forward the streaming media before it will resume back to a real time mode. Or display to a user how much more time they can pause the media stream before the processor resumes displaying the media in a normal display mode. A user can also select a specific amount of time skip for example to skip forward over a commercial.

One way to measure the time difference is simply to identify the index for the media that is currently being decoded. Then the processor 120 may count back or forward a number of index values in the object index table 372 (FIG. 8) that are associated with the time forward or back request. For example, a user may request a skip forward of two minutes. The processor 120 would skip forward 120 index values (one second per index) and then start decoding media from the identified index location in memory 128.

In a real time mode situation where the user has pressed the pause button, the processor 120 can use a timer to measure the amount of time from when the user first pressed the pause button and compare that to a current time. The time difference is then compared to the amount of forward or back media stored in memory 128 to determine and possibly display to the user how much more time is available for the pause, forward or reverse operation before the system starts displaying video again at a normal output rate.

Detailed Explanation of Object Index Table Generation

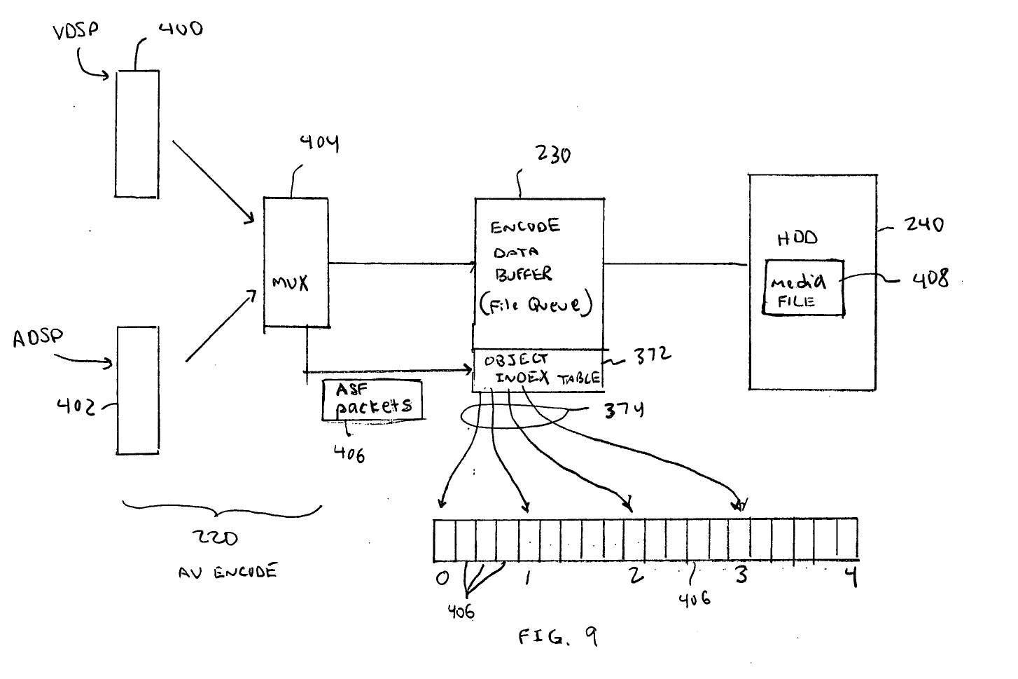

Referring to FIG. 9, the encoder portion of the video recording system 200 includes a buffer 400 that is associated with a video DSP (VDSP) and a buffer 402 associated with an audio DSP (ADSP). The video DSP and audio DSP each store media inside their respective buffers 400 and 402. The media from the two buffers 400 and 402 is combined inside a muxing buffer 404. The buffers 400, 402 and 404 may all be part of the av encoder 220 shown in FIG. 4. The media in mux buffer 404 is sent to the encode data buffer 230 (file queue) and then eventually gets stored on the Hard Disc Drive 240.

The processor 110 (FIG. 7) formats the video and audio frames in buffers 400 and 402 into ASF packets 406. The processor 110 generates a pointer 374 for each group of ASF packets 406 that define some desired time interval. For example, as described above, an index 374 may be generated for each second of media. The processor 110 identifies the ASF packets 406, or the locations in memory, associated with each sequential second of media.

The processor 110 also keeps track of the total number of indices 374 that exist in the object index table 372. Table 372 operates as a circular buffer as described in FIGS. 5 and 6, therefore allowing the processor 110 or 120 to keep track of the amount of media stored in memory 230 and 240 and can perform operations as described above to prevent media from being discarded.

For example, the HDD 240 may have the capacity to retain 30 minutes of video data and the object index table 372 may include one index for each second of video. The processor 110 knows it can generate 1800 indexes 374 before having to replace the oldest media with new encoded media.

As described above, prior indexing systems wait until the media file 408 has been closed, for example, by a user hitting a video stop button before generating an index table. The index table is then attached to the media file in the same memory. The current media file 408 used in the present invention does not require a ASF header 360 (FIG. 8) or an attached object index table 364.

The processor 110 generates another index 374 in the object index table 372 each time enough ASF packets 406 are generated to provide another one second of video. For example, the processor 110 may generate or update an index value 374 in table 372 each time five ASF packets 406 are received from the mux buffer 404. Or when the indexes in the ASF packets 406 indicate another one second of media has been received in the encode data buffer 230. Of course other time divisions longer or shorter than 1 second can also be used.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. We claim all modifications and variation coming within the spirit and scope of the following claims.

1. A media display system, comprising:
a processor receiving media and generating an object index table for the media in real-time as the media is being received, the object index table containing index values identifying associated portions of the media for different corresponding media time periods.

2. The media display system according to claim 1 wherein the processor formats the received media into an Advanced Systems Format (ASF) file and generates the index values in the object index table at the same time the associated media portions are being encoded and stored into the ASF file.

3. The media display system according to claim 1 wherein the processor identifies a media display time that corresponds with a media display command, the processor using the object index table to locate and display non-encoded media in a first initial buffer memory when the media display time is in a first previous time range and using the object index table to locate and display encoded media in a second larger capacity memory when the media display time is in a second time range prior to the first time range.

4. The media display system according to claim 1 wherein the processor:
receives a media skip command;
identifies a media skip time corresponding to the media skip command;
uses the object index table to identify the media location corresponding to the identified media skip time; and
outputs the media from the identified media location.

5. The media display system according to claim 4 wherein the processor:
receives multiple skip forward and/or skip backward commands;
accumulates media skip times associated with the multiple skip forward and/or skip backward commands;
uses the object table to identify the media location corresponding to the accumulated media skip times; and
outputs the media from the identified media location.

6. The media recording system according to claim 4 wherein the processor:
compares the identified media skip time with an index in the object index table identifying either the oldest stored media time or the newest stored media time and automatically starts outputting real-time media when the identified media skip time is around or before the newest stored media time and automatically starts outputting media from the oldest stored media location when the media skip time is around or prior to the oldest stored media time.

7. The media recording system according to claim 1 wherein the processor:
receives a fast forward or rewind command;
identifies a media speed up rate for the fast forward or rewind command;
identifies an amount of time the fast forward or rewind command is activated;
derives a media target time according to the identified media speed up rate and the identified fast forward or rewind command activation time;
applies the derived media target time to the object index table to identify the final media location for the fast forward or rewind command; and
either fast forwards or rewinds the media at the identified speed up rate until the final media location is reached.

8. A media processing device, comprising:
a processor configured to buffer media in one or more storage devices and play out the media at different media locations or at different speeds according to different media display modes, the processor adjusting the processing rate for encoding or outputting frames for the media when the media display modes may cause backups in one or more of the storage devices.

9. The media processing device according to claim 8 wherein the processor adjusts the processing rate by reducing the rate that media frames are updated or adjusting a sample rate used for encoding the media.

10. The media processing device according to claim 8 wherein the processing rate is adjusted according to an amount of pause, rewind, or skip operations performed on the media.

11. The media processing device according to claim 8 wherein the processor or an alternative device operate a filter that reduces a receive rate for the media according to different media display modes used for displaying the media.

12. The media processing device according to claim 11 wherein the processor reduces the resolution of the received media when the received media has a low compression level.

13. The media processing device according to claim 8 wherein the processor changes a frame output rate or encoding level for the media displayed on a television according to different trick-modes used by the television for displaying the media.

13. The media processing device according to claim 8 wherein the processor generates pointers in real-time as different portions of the media are being received, the pointers indexing the different portions of the media associated with different media time periods.

14. A method for processing media in a television, comprising:
receiving the media in the television;
receiving portions of the media in the television for predefined time intervals;
generating index values identify the media portions as the individual portions are received in the television; and
using the generated index values when operating the television in different display trick modes.

15. The method according to claim 14 including:
identifying a first index value associated with the media currently being decoded and displayed on the television;
identifying a second index value identifying the media that is currently being received and encoded in the television;
identifying a time difference between the first and second index value; and
displaying the time difference on the television to identify an amount of captured media in the television.

16. The method according to claim 15 including:
receiving a media display request;
identifying an amount of time shift associated with the request;
comparing the identified time shift with the amount of captured media; and
identifying an amount of captured media that would remain after the media display request is executed.

17. The method according to claim 14 including:
identifying a start time when a user first initiates a media pause, fast forward, or reverse operation;
comparing the start time with a current time to determine a media manipulation time;
comparing the media manipulation time with an amount of media stored forward in time or stored back in time; and
using the comparison to determine how much more time is available for the pause, fast forward or reverse operation.

18. The method according to claim 14 including:
monitoring for a threshold value for encoded data that requires storage into main memory or for encoded data in main memory that needs to be output;
varying an encoding rate to reduce the amount of encoded data that needs to be stored in main memory or varying an output display rate to reduce the amount of encoded data in main memory that needs to be output according to the threshold data value.

19. A media system, comprising:
a first memory configured to store media; and
a first processor configured to write the media into the first memory and then output the media from the first memory at different time shifted media locations according to user selectable display modes, an encoding rate or output rate for the media varied according to an amount of time shifting required when the main processor outputs the media from the first memory.

20. The media system according to claim 19 including:
a second processor used for encoding incoming media; and
a second memory used by the second processor to store the encoded media.

21. The media system according to claim 20 wherein the first processor transfers the encoded media in the second memory to the first memory and then reads and decodes the encoded media from the first memory for sending to a display unit.

22. The media system according to claim 20 wherein the second processor reduces the amount of encoded media generated from the incoming media according to an amount of encoded media backed up in the second memory.

23. The media system according to claim 20 wherein the first processor reduces the rate that the encoded media needs to be read from the first memory according to the amount of time shifting required when reading the encoded media from the first memory.

24. The media system according to claim 20 wherein the first processor receives the media un-encoded directly from the second processor when there is no time shifting required when outputting the media.

25. The media system according to claim 20 wherein the main processor reads the encoded media from the second memory for relatively short media time shifted play out requests and reads the encoded media from the first memory for relatively longer media time shifted play out requests.
